(19) United States
(12) Patent Application Publication
(10) Pub. No.: US 2008/0193687 A1
(43) Pub. Date: Aug. 14, 2008

(54) BASE PAPER FOR MOLDING CONTAINER AND PAPER-MADE MOLDING CONTAINER

(75) Inventors: Yoshiyuki Asayama, Tokyo (JP); Yasushi Jiromaru, Tokyo (JP); Yoshinobu Abou, Gifu-ken (JP); Katsunori Hata, Gifu-ken (JP); Mitsunori Taima, Gifu-ken (JP); Yoshiro Fujimori, Gifu-ken (JP)

Correspondence Address: KNOBBE MARTENS OLSON & BEAR LLP, 2040 MAIN STREET, FOURTEENTH FLOOR, IRVINE, CA, 92614, US

(73) Assignees: Oji Paper Co., Ltd., Tokyo (JP); Oji Specialty Paper Co., Ltd., Tokyo (JP)

(21) Appl. No.: 11/877,329

(22) Filed: Oct. 23, 2007

(30) Foreign Application Priority Data
Feb. 14, 2007 (JP) P2007-033000

(51) Int. Cl. B32B 1/08

(52) U.S. Cl. 428/34.2; 428/340

(57) ABSTRACT

A base paper for a molding container including a substrate paper having a basis weight of 100 to 500 g/m2 and overall density of 0.4 to 0.7 g/cm3 and which has a high density layer having a density of 0.7 to 0.9 g/cm3 and a low density layer having a density of less than 0.7 g/cm3; and a release agent layer which is provided on at least one surface of the substrate paper and which may be provided via an undercoat layer, wherein the low density layer is mainly constituted of at least one pulp selected from the group consisting of mechanical pulp, curled fibers, and mercerized pulp; and wherein air permeability defined in JIS-P8117 is 100 to 5000.

### BACKGROUND OF THE INVENTION

1. Field of the Invention

The present invention relates to a base paper for a molding container, in order to obtain a paper-made molding container which can favorably be used as a baking pan for foods such as bread, cake, and confectionary that are produced by cooking, and a paper-made molding container.

2. Description of the Related Art

Conventionally, foods such as bread, cake, and confectionary which are produced by cooking are usually made by putting a combination of ingredients in a baking pan, which is made of various materials, to cook. For example, a baking pan has been made by using a base paper for a food container in which a release agent layer of silicone resin or the like is provided on a paper substrate to impart oil resistance, heat resistance, and release properties (Patent Documents 1 and 2).

Baking pans using paper as a substrate are inexpensive compared to the baking pans using metals or silicone resin, and thus they are widely used even at present. However, such paper substrates are not always satisfactory in terms of strength.

Additionally, in such an application as a baking pan, a container shape in which joints are absent in the bottom and side surface sections is desired. A cup-shaped container made by press molding (refer to Patent Document 2, FIG. 5) and a four-corner glued tray (refer to Patent Document 2, FIG. 4) are favorable for cylindrical types and rectangular types, respectively. However, in the case of a cup-shaped container which is molded by press molding common base papers, strength and shape stability are not satisfactory and moreover, the degree of freedom in terms of shape is currently close to none. Accordingly, it has been impossible to manufacture a product having various complex shapes. In addition, when using a base paper where a release agent is coated on a substrate, adhesion onto a release agent-coated surface using an adhesive was difficult, and thus there were problems in productivity and shape stability as a result.

Moreover, baking pans in which a film (such as polyethylene terephthalate) and paper substrate are pasted together in order to improve shape stability and strength have been used (refer to Patent Documents 3 and 4). However, pasting of paper substrates and films led to the problem of impairment of easy disposability and recyclability of paper. In addition, another problem, that is, the absence of degree of freedom in terms of shape, has not been resolved. Furthermore, by laminating films, there have been cases where air permeability or gas permeability (such as water vapor permeability) of substrates is impaired and, as a result, the release of gases such as the water vapor generated from food materials at the time of cooking was prevented, which led to the deformation of containers or deterioration in food appearance. Additionally, at the time of cooking, since gases having high temperature do not reach inside the container, there have been problems such as the prevention of food browning or prevention of uniform heating. Although such problems have been dealt with by providing holes at the bottom of a container, an extra process was required for opening holes and there were cases where the food appearance was impaired.

Furthermore, there is a baking pan tray made by press molding for bread and the like using a substrate paper, in which pulp and synthetic fibers are mixed and combined, in order to enhance the degree of freedom in terms of shape (refer to Patent Document 5). As for such a tray, since it contains many synthetic resin fibers which are thermoplastic, there were problems such as inferior heat resistance when used as a baking pan, lack of air permeability and durability when used repeatedly.

[Patent Document 1] Japanese Unexamined Patent Application, First Publication No. Sho 53-086819

### [Patent Document 2] Japanese Laid-Open Patent Application No. 2002-326691

[Patent Document 3] Japanese Unexamined Patent Application, First Publication No. Hei 07-264964

### [Patent Document 4] Japanese Laid-Open Patent Application No. 2000-109157

### [Patent Document 5] Japanese Utility Model Publication No. 3116832

### [Patent Document 6] Japanese Laid-Open Patent Application No. 2002-201598

The present invention was made in order to solve the above problems.

In other words, according to the present invention, a paper-made molding container usable as a baking pan which has oil resistance, release properties, heat resistance, appropriate gas permeability, and a high degree of freedom in terms of molding, and which also has sufficient strength and shape stability to be used repeatedly, and a base paper for a molding container which is capable of providing said container can be obtained.

### SUMMARY OF THE INVENTION

In order to solve the abovementioned problems, the present invention is configured by the following aspects.

A first aspect of the present invention is a base paper for a molding container having a substrate paper having a basis weight of 100 to 500 g/m² and overall density of 0.4 to 0.7 g/cm³ and which has a high density layer having a density of 0.7 to 0.9 g/cm³ and a low density layer having a density of less than 0.7 g/cm³; and a release agent layer which is provided on at least one surface of the substrate paper and which is provided via an undercoat layer when necessary. The low density layer is mainly constituted of at least one pulp selected from the group consisting of mechanical pulp, curled fibers, and mercerized pulp, and air permeability (defined in JIS-P8117) of the base paper is 100 to 5000.

A second aspect of the present invention is a base paper for a molding container according to the first aspect in which the substrate paper satisfies the following conditions (1) to (4); i.e.
(1) a tensile strength (defined in JIS-P8113) of at least 2.0 kN/m,
(2) a breaking elongation (defined in JIS-P8113) of at least 1.5%,
(3) a critical compressive stress, which is derived by dividing compressive strength (defined in JIS-P8126) by area of a loaded part of a test piece in the determination of the compressive strength, within a range of 1 to 10 MPa,
(4) an amount of compressive deformation of at least 10% when 20 kgf/cm² of compressive stress is applied in a thickness direction

A third aspect of the present invention is a base paper for a molding container according to the first or second aspect in which the release agent layer is formed from a silicone resin.

A fourth aspect of the present invention is a container made by press molding which is produced by using a base paper for a molding container of the first or second aspect.

A fifth aspect of the present invention is a container made by press molding which is produced by using a base paper for a molding container of the third aspect.

A sixth aspect of the present invention is a tray carton which is produced by using a base paper for a molding container of the first or second aspect.

A seventh aspect of the present invention is a tray carton which is produced by using a base paper for a molding container of the third aspect.

The eighth aspect of the present invention is a container made by press molding according to the fourth or fifth aspect which is used as a baking pan for cooking.

The ninth aspect of the present invention is a tray carton according to the sixth or seventh aspect which is used as a baking pan for cooking.

According to the present invention, it has become possible to obtain a paper-made molding container (i.e. a container made by press molding or a tray carton) usable as a baking pan, which has oil resistance, release properties, heat resistance, appropriate gas permeability, and a high degree of freedom in terms of molding, and which also has sufficient strength and shape stability to be used repeatedly, and a base paper for a molding container which is capable of providing said container. Further, by cooking food materials using the aforementioned paper-made molding container, uniform heating can be achieved, and thus it is possible to obtain food products which are uniformly browned and having beautiful appearance.

### BRIEF DESCRIPTION OF THE DRAWINGS

FIG. 1 is a perspective view of an Example obtained by press molding the base paper of the present invention for a molding container.

FIG. 2 is a perspective view of another Example obtained by press molding the base paper of the present invention for a molding container.

FIG. 3 is a perspective view of yet another Example obtained by press molding the base paper of the present invention for a molding container.

FIG. 4 is a diagram showing a blank sheet of another Example of the present invention.

FIG. 5 is a perspective view of yet another Example of the present invention obtained by molding the blank sheet shown in FIG. 4 into a tray carton shape.

### DETAILED DESCRIPTION OF THE INVENTION

As the substrate paper used in the base paper for a molding container in the present invention, it is preferable to use a paper which is made into a multilayered structure having two or more layers which include a low density layer, which has a density of less than 0.7 g/cm³, and high density layer, which has a density of 0.7 to 0.9 g/cm³, and in which the overall density is 0.4 to 0.7 g/cm³ at the same time. The density of the low density layer is preferably 0.2 to 0.65 g/cm³.

Although the above paper made into a multilayered structure may have one lower density layer and one high density layer each, it is more desirable to make it into a structure where the intermediate layer, which is a low density layer, is sandwiched between the two outer layers, both of which are high density layers, because it is more effective in obtaining the base paper having more bulkiness and higher stiffness.

The stiffness S of sheets such as paper and boards is represented by the following formulae when assuming the sheet is a cantilever:

S=E·I/B·W=E·T³/12·W

where E represents Young's modulus (MPa), I represents second moment of the area (N·cm²), B represents the width of the sample (mm), W represents the weight of the sample (kg), and T represents the thickness of the sample (mm). Namely, the stiffness S can be considered to be proportional to Young's modulus and the cube of the sheet thickness.

In addition, as for the stiffness of a sheet having a multilayer structure like the paper board, according to A. T. Luey (Tappi November 1963, Vol. 46, No. 11), the value of the stiffness in each layer is determined from Young's modulus and second moment of the area of each layer using the aforementioned formulae, and then, the overall stiffness of the sheet can be determined by calculating the sum of the stiffness values in the respective layers.

Based on this idea, the stiffness becomes higher as the distance from the center of the paper thickness becomes longer or, in other words, as the paper thickens. Accordingly, it is better to make the intermediate layer bulky. Additionally, since the stiffness is represented by the cube of the thickness multiplied by Young's modulus, it is effective for the stiffness improvement as Young's modulus increases towards the outer layer.

For this reason, the density of the intermediate layer is less than 0.7 g/cm³ and preferably 0.2 to 0.65 g/cm³ and more preferably 0.3 to 0.6 g/cm³. When the density of the intermediate layer is less than 0.2 g/cm³, interlaminar strength is considerably reduced whereas when it is more than 0.7 g/cm³, the overall density of the base paper cannot be controlled within the range of 0.4 to 0.7 g/cm³.

The density of the outer layer is preferably 0.7 to 0.9 g/cm³. When the density of the outer layer is less than 0.7 g/cm³, the Young's modulus of the outer layer is low and the improvement in the stiffness of the present invention cannot be expected. On the other hand, when the density is more than 0.9 g/cm³, the surface of the outer layer of the base paper becomes too tight, and thus not only is it substantially difficult to obtain a layer having any higher density in the paper making stage but also the suitability for press molding cannot be achieved.

Although the kinds of the pulp used in the high density layer are not particularly limited, those obtained by a high degree of beating of conifer pulp such as NUKP and NBKP to maintain its stiffness are particularly desirable. Note that the basis weight of the outer layer, which is made to be a high density layer, is preferably 15 to 100 g/m² in order to make the present invention effective. When the basis weight is less than 15 g/m², it is difficult to obtain a layer having a high Young's modulus and the paper making itself is also difficult. On the other hand, when the basis weight of the outer layer is more than 100 g/m², the basis weight of the low density layer relatively reduces and, as a result, the overall density of the base paper increases, and thus making it difficult to control the overall density within the range of 0.4 to 0.7 g/cm³.

The production of a paper, which will be made to be multilayered and which will be the substrate paper of the present invention, is carried out using a multilayer-combining former like one used in the production of common paperboards.

The pulp used for forming the low density layer in the present invention is favorably one that has a freeness conforming to Canadian Standard and defined in JIS-P8121 within the range of 200 to 650 ml in a redissociated state. When the freeness is less than 200 ml, the pulp fibers cannot be easily dehydrated and, as a result, the dehydrated sheet will have a dense structure. This makes the production of a paper layer structure having a low density difficult. On the other hand, when the freeness is more than 650 ml, the density of the sheet will become excessively low resulting in the occurrence of ply separation during the pressing process in the paper making, and thus balloon-like swelling easily occurs. Note that the stock having a freeness of 200 to 650 ml in a redissociated state can be adjusted to one having a freeness of 250 to 700 ml in terms of Canadian Standard regardless of the pulp material used.

Additionally, the determination of the freeness of the pulp used by redissociating the base paper is effective in knowing necessary pulp properties in a short time from a product having excellent operation properties.

Although the pulp material used for forming the low density layer can be selected arbitrarily, it is preferable to make the pulp material, from which a paper layer having a low density is easily achieved, as a major constituent. Specific examples of such a pulp include a mechanical pulp. Although the mechanical pulp includes GP, TMP, and RGP, TMP and RGP are particularly preferable. Among them, those made from radiata pine, southern pine, Douglas fir, or the like are particularly preferred since the paper layer having a low density can be obtained and the density reduction at the time of press molding is also small due to the property thereof where fibers are rigid and are not easily deformed.

Note that those pulps which are partially treated chemically such as the pulp obtained by adding chemicals at the time of mechanical crushing and pulp which is subjected to a bleaching treatment are also treated as mechanical pulps in the present invention. Moreover, those where pulps are provided with a property to achieve low density by a chemical treatment such as mercerized pulp and curled fibers can also be used favorably.

Although the aforementioned pulp is used as a main constituent in the present invention in order to configure the low density layer, it is also possible to use others such as a chemical pulp made from normally used wood or a chemical pulp made from a various non-wood materials by mixing them where appropriate.

In any case, in the present invention, various pulps are selected so that the density of the low density layer is 0.2 g/cm³ or more and less than 0.7 g/cm³, and it is desirable to mix and use plural kinds thereof when required.

Note that in the present invention, it is more desirable that the substrate paper contain 50% or more of at least any one of the mechanical pulp, mercerized pulp, and curled fibers, out of the total pulps.

The pulp constituting a substrate paper of a base paper for a molding container in the present invention will be described below.

Wood fibers (chemical pulps and mechanical pulps), non-wood fibers and recycled pulps are used arbitrarily as natural pulps where necessary. Among the wood fibers, examples of the chemical pulps include kraft pulps and sulfite pulps. These pulps may be untreated or bleached. Additionally, examples of the mechanical pulps include ground wood pulps (GP), refiner ground wood pulps (RGP), and thermomechanical pulps (TMP), which are obtained by heating and refining wood chips.

Among these mechanical pulps, TMP is most suited in view of the bulkiness and strength of the resulting sheets. Note that TMP also includes C-TMP obtained by the chemical treatment of the wood chips followed by refining under pressure, and BC-TMP obtained by additional bleaching treatment. Additionally, among such wood fiber pulps, those obtained from conifers which have long fibers are favorably used in order to improve the extensibility and strength of the base papers.

In addition, bast fibers such as paper mulberry, kenaf, and jute; seed hair fibers such as cotton and cotton linters; leaf fibers such as Manila hemp and sisal; and stem fibers such as bamboo and bagasse can be used arbitrarily as non-wood fibers where necessary. In particular, paper mulberry, paper bush, kenaf, Manila hemp, sisal, cotton, cotton linters, or the like are favorably used since they have long fibers and are capable of improving the extensibility and strength of the base paper of the present invention.

Note that various recycled pulps can also be used where necessary in the present invention.

The abovementioned various pulp fibers can be used alone or in combination of two or more kinds thereof. Moreover, synthetic resin fibers can be mixed with the fibers where necessary as long as the effect of the present invention is not impaired.

The substrate paper of the base paper of the present invention for a molding container has a tensile strength (JIS-P 8113) of at least 2.0 kN/m and preferably at least 10 kN/m, and preferably has a breaking elongation (JIS-P 8113) of at least 1.5%. When the substrate paper has a tensile strength of less than 2.0 kN/m or a breaking elongation of less than 1.5%, the extensibility thereof is low and the substrate paper is broken at the time of press molding, and thus, it is unfavorable.

Note that in order to control the tensile strength and breaking elongation within the above range, known methods can be applied for the control: for example, NBKP is partially used in the pulp or the loadings of paper strength additive is adjusted; or when the paper layer is a multilayer, NBKP is used in at least one of these layers or a paper strength additive is mixed therein.

In the case where a molded body has a curved section, in which distortion is high, it is necessary to absorb the distortion by forming folding creases in the curved section when press molding a flat base paper. In this case, the creased portion is interfolded in the plane direction like an accordion to form an uneven surface and then the uneven surface is compressed in the thickness direction by the pressing.

For this reason, in order to obtain favorable press moldabilily, the critical compressive stress of the substrate paper is in the range of 1 to 10 MPa, preferably 5 to 10 MPa, and the compressibility in the thickness direction is preferably in the range of 10% or more.

Note that the term “compressibility” in the present invention refers to the compressibility in the thickness direction when a compressive stress of 20 kgf/cm² is applied. When the critical compressive stress exceeds 10 MPa, the creased portion is not interfolded sufficiently. When the compressibility is less than 10%, the compression molding in the creased portion becomes insufficient, and thus favorable moldability cannot be obtained.

For controlling the critical compressive stress and the compressibility in the thickness direction within the above ranges, the density of the substrate paper needs to be kept low. For this purpose, rigid pulp fibers are suited. Generally, pulp fibers are beaten to obtain a paper sheet having a uniform formation (namely, a mechanical external force is applied to the pulp fibers to partially fibrillate the cellular walls of the fibers). However, in the present invention, the beating should be kept light so as to maintain the stiffness of the fibers.

For example, the degree of the beating is preferably controlled so that the freeness (Tappi T-227: Canadian Standard Freeness) of chemical pulps should be at least 500 mlcsf, that of mechanical pulps should be at least 180 mlcsf; that of hemp pulp and kenaf pulp should be at least 500 mlcsf, and that of recycled pulps from corrugated cardboards should be at least 500 mlcsf. Note that for beating the pulp fibers, various refiners which are conventionally used can be used where appropriate.

Additionally, a foaming agent can also be added at the time of paper making in order to lower the density as long as the effect of the present invention is not impaired. Examples of the foaming agent include heat-expandable microcapsules encapsulating a solvent with a low boiling point. In addition, it is also possible to add light inorganic pigments such as shirasu balloons in order to lower the density.

Chemicals, which can be used where necessary for producing the substrate paper of the present invention and which are added to the stock, are sizing agents, paper strength additives, yield improvers, or the like which are the same as those usually used in paper making. These chemicals for paper making can be added by spraying between the paper layers during the paper making process or by applying onto the surface of the base paper during or after paper making.

Moreover, a filler, which is the same as those usually used for making paper during the paper making, can be added where necessary in an arbitrary combination.

Furthermore, auxiliaries for paper making such as a dye, pH adjuster, slime controller, defoamer, and thickener can also be used arbitrarily depending on the purpose.

At the time of making papers in the present invention, pH is arbitrarily selected within the range of about 4.5 (when making acidic papers) to about 6 to 8 (when making neutralized paper) when needed.

Paper is made by the common method using the stock composed of the abovementioned materials. The paper machine used is not particularly limited and any form of a paper machine which has been used conventionally can be selected where appropriate. Moreover, also in the drying process, the dryer is not particularly limited and any form of a dryer which has been used conventionally can be selected where appropriate.

In addition, in the present invention, the substrate paper obtained from the abovementioned paper making process is a multilayered paper composed of two or more layers.

The basis weight of the substrate paper obtained as such is preferably in the range of 100 to 500 g/m², and more preferably 200 to 400 g/m². When the basis weight is lower than 100 g/m², the molded body obtained after the press molding cannot develop a sufficient strength. On the other hand, when the basis weight is more than 500 g/m², the moldability of the creased portion is reduced, and thus it is unfavorable.

The paper satisfying the conditions (1) to (4) of the present invention as stated above can be prepared by the aforementioned method. However, in order to balance the strength, elongation, stiffness and compressibility, it is most preferable to use a multilayered paper having an intermediate layer, which is mainly composed of a mechanical pulp and with a density of less than 0.7 g/cm³, between the two outer layers, which are mainly composed of a kraft pulp or a woodfree recycled paper and with a density of 0.7 to 0.9 g/cm³, and having a density of 0.4 to 0.7 g/cm³.

The present invention in characterized in that a release agent layer is provided on at least one surface of the substrate paper obtained as described earlier. As a forming method of a release agent layer, coating of release agent liquid is preferable. Coating of the release agent liquid can be carried out using an arbitrarily selected, known coating facility such as a gate roll coater, bar coater, roll coater, air knife coater, and blade coater. More preferably, coating by gravure coater or bar coater can be carried out for the reason that those having low concentration and low viscosity are coated.

The release agent layer of the present invention is favorably formed by silicone resin or fluorine-based resin from the viewpoints of food safety and release properties from food, and above all, silicone resin is used most favorably from the safety aspect.

In the present invention, the base paper for a molding container preferably has gas permeability.

The reason for this is as follows. When using a paper-made molding container formed from the abovementioned base paper as a baking pan, a large amount of water vapor is generated at the time of cooking since most food materials contain water. In addition, a large amount of gases such as carbon dioxide are also generated from baking powder or the like contained in bread and baked pastries. Accordingly, by having a container with appropriate gas permeability, container deformation and effects on the appearance of food due to the deformation can be avoided.

Moreover, when water-vapor permeability is insufficient, release of water vapor, which is generated at the time of cooking, is prevented. Accordingly, water vapor drastically forces itself to be released in the thickness direction of a container paper while the pressure is high, and thus pinholes, delamination, or the like occurs at times in the release agent layer which is provided by coating. As a result, it is possible that the release properties of food after cooking are deteriorated.

In addition, when air permeability is not sufficient, high temperature gases outside the container cannot reach inside of the container at the time of cooking, and thus there were problems such as the prevention of food browning and prevention of uniform heating. Although such problems can also be dealt with by opening holes at the bottom part of the container, it was possible that an extra process was required or that food appearance was impaired.

In the present invention, air permeability (JIS-P8117) required for the base paper for a molding container from the abovementioned reasons is specifically 100 to 5000 seconds. When it exceeds 5000 seconds, air permeability and water vapor permeability are not sufficient causing problems such as the prevention of food browning at the time of cooking and generation of pinholes in the release agent layer. Additionally, when it is less than 100 seconds, formation of the release agent layer will not be sufficient, and thus release properties from food are not exhibited when used as a baking pan. By cooking food materials using the paper-made molding container of the present invention, uniform heating can be achieved, and thus it is possible to obtain food products which are uniformly browned and having beautiful appearance.

The release agent layer in the present invention is formed from a silicone resin, fluorine-based resin, or the resin containing these resins.

Specific examples of the fluorine-based resin which can be used in the present invention in order to form the release agent layer include polytetrafluoroethylene resin, 4-fluoroethylene/6-fluoropropylene copolymer resin, ethylene/tetrafluoroethylene copolymer resin, polyfluorovinylidene resin, and polyfluorovinyl resin. These can be used alone or in combination of two or more kinds arbitrarily.

Additionally, specific examples of the silicone resin which can be used in the present invention in order to form the release agent layer include hydrolysates, polymers, or the like of trimethylchlorosilane, dimethyldichlorosilane, methyltrichlorosilane, diphenyldichlorosi lane, phenyltrichlorosilane, methylvinyldichlorosilane, or the like. These can be used alone or in combination of two or more kinds arbitrarily.

Moreover, in terms of the form of silicone resin, any forms of solvent form, solventless form, and emulsion form can be used. Among them, solventless form is favorable from the viewpoints of odor and safety.

In addition, the coating amount of silicone resin is preferably 0.5 to 3.0 g/m². When the coating amount is less than 0.5 g/m², release properties from food are impaired whereas when the coating amount exceeds 3.0 g/m², not only economic efficiency is impaired but also gas permeability and water vapor permeability are impaired, and thus it is not preferable.

In the present invention, it is preferable to provide an undercoat layer between the substrate paper and the aforementioned release agent layer for the sake of preventing the infiltration of release agent liquid to substrate paper for efficient coating and bringing out release properties effectively. Undercoat layers are particularly preferable from the viewpoint that water-soluble resin such as polyvinyl alcohol and polystyrene/acryl copolymer, or aqueous emulsion carries out the infiltration prevention of release agent effectively without reducing air permeability.

In addition, the coating amount of the abovementioned undercoat layer is preferably 0.2 to 2.0 g/m² and more preferably 0.5 to 1.0 g/m². When the coating amount is less than 0.2 g/m², release properties from food are impaired whereas when the coating amount exceeds 2.0 g/m², gas permeability and water vapor permeability are impaired, and thus it is not preferable.

Next press molding of said base paper for a molding container and paper-made molding container obtained by the press molding will be described.

### <Molding Method>

### (1) Water Content Adjustment of Base Paper

The production method of the paper-made molding container of the present invention is press molding (draw forming) where a base paper for a molding container is stamped out into a container blank sheet, ruled lines are drawn in necessary places, and said blank sheet is sandwiched in a press mold composed of a male mold and female mold and is subjected to heat and applied pressure to mold.

In this process, the base paper for a molding container is preferably subjected to a conditioning treatment in advance to regulate the water content in the base paper. The water content of the base paper is preferably within a range of 10 to 20% and more preferably 11 to 17%, even more preferably 12 to 15%, and most preferably 12.5 to 14.5%. Note that the water content in base paper refers to the water content (represented in weight %) relative to the absolute dry weight, which corresponds to the total pulp in the base paper. When the water content of base paper is controlled within the above preferable range, the base paper for a molding container plasticizes to improve the moldability thereof and the breaking of paper layers at the time of molding is also reduced. As a result, it is possible to obtain a molding container which has an increased depth, smooth and beautiful appearance, and high rigidity. When the water content of base paper is less than 10%, a molded body with sufficient rigidity is not achieved. On the other hand, when the water content of base paper exceeds 20%, it is not preferable since problems such as the delamination of paper layers in base paper due to the occurrence of blisters in molded base papers and longer drying time resulting in a drop in productivity due to high water content, may occur.

### (2) Molding Method

Next, the process for producing a paper-made molding container from a blank sheet by process molding will be described.

Press molding is carried out using a pair of press dies in the present invention. A pair of dies for heat press molding is composed of a convex mold, which has a convex shape and which corresponds to the internal portion of a molded product, and concave mold, which has a concave shape and which corresponds to the external shape of the molded product. The aforementioned pair of press dies is capable of pressing a molded container due to the movement of at least one mold in the anteroposterior or the vertical direction.

In the present invention, it is preferable to heat a blank sheet, press dies, or even both during the press molding. Arbitrary means such as high-frequency heating, hot-air heating, and infrared heating is used for heating the blank sheet.

Additionally, although press dies are generally heated by an electrothermal heating apparatus which is provided in said press dies, it is also possible to heat them due to high frequency application by providing them with a high-frequency oscillator. Moreover, both of these apparatuses can be used concomitantly.

In addition, heating temperature during molding is preferably within a range so that the molded base paper is 100 to 150° C. more preferably 110 to 140° C. When the temperature of the molded base paper is less than 100° C., it takes a long time to mold and results in a drop in productivity. On the other hand, when the temperature of the molded base paper exceeds 150° C., it is not preferable since blisters are likely to occur especially when water content of the base paper is high.

Although containers, in which press molding is completed, may be cooled in air by taking them out of dies, it is preferable to cool the containers having high temperature by fixing them in a cooling die for a given time in order to enhance dimensional stability.

Known materials such as aluminum and aluminum-based alloys can be selected and be used as materials for the aforementioned heat pressing mold where appropriate.

Known mechanisms which have been used conventionally such as an oil pressure mechanism, air pressure mechanism, and cam mechanism can be adopted as the method to operate dies where appropriate. As the method to control the clearance of upper and lower molds during press molding, respective pressures can be controlled by computer control depending on the thickness of a molded product when adopting an oil pressure mechanism or air pressure mechanism. In addition, it is possible to control the position of a stopper. When adopting a cam mechanism, the control is possible by the cam shape and lowering rate of molds which are designed in advance.

Pressure during press molding is preferably within a range of 10 to 100 kgf/cm². When the pressure is less than 10 kgf/cm², it is possible that compressive deformation at the ruled-line part is insufficient. On the other hand, when the pressure exceeds 100 kgf/cm², it is possible that paper layers at the folding-crease part break, and thus it is not preferable.

As for the pressing time during press molding, a range of 2 to 30 seconds is preferable from the viewpoints of moldability and workability.

### <Characteristics of Base Paper Under High Temperature/High Humidity Conditions>

Breaking strength (tensile strength) of base paper for a molding container weakens under high temperature/high humidity conditions like those during press molding and the base paper breaks by a small force. Moreover, under high humidity conditions, breaking elongation also reduces as temperature increases; i.e. a base paper tends to break easily. For this reason, tensile properties of base papers under high temperature/high humidity conditions are important requirements in draw forming property. However, it is difficult to actually measure the temperature and water content of base papers during molding. Additionally, it is not easy to measure the tensile properties of base papers in high temperature/high humidity conditions.

However, the present inventors discovered, as a result of their studies, that the base paper for a molding container, which satisfies the following conditions under the conditions of a temperature of 23° C. and water content (in paper) of 14 weight %, are suited for draw forming in high temperature/high humidity conditions.

(1) Breaking elongation (defined in JIS-P8113) in the vertical direction is 2% or more and preferably 3% or more
(2) Tensile modulus in the vertical direction is within a range of 1000 to 2000 MPa and preferably 1200 to 1800 MPa Note that the abovementioned water content (in paper) refers to a value which is derived by dividing the weight of water in a paper with the total weight of the paper (i.e. weight of pulp+weight of additives+weight of water) at the time point where elongation or elastic modulus is measured.

It should also be noted that the abovementioned measurements are those carried out in a substrate-paper state where coated layers are not present.

In the case where breaking elongation in the vertical direction is less than 2% when temperature is 23° C. and water content (in paper) is 14 weight %, it is possible that a problem of breaking occurs during press molding due to low extensibility.

Moreover, in the case where the range of tensile modulus is 2500 MPa or less when temperature is 23° C. and water content (in paper) is 14 weight %, fluidity of pulp fibers of molded base paper is enhanced and the breaking of paper layers at the folding-crease part during molding can be reduced. As a result, a molded product with high strength can be obtained. When the aforementioned tensile modulus is less than 1000 MPa, it is possible that a problem of insufficient rigidity of molding container occurs.

### <Container Shape>

The paper-made molding containers which the present invention is aiming at are containers obtained by draw forming (press molding) a sheet of paper using a press die, which is composed of a pair of a convex mold and concave mold.

A representative form of the above containers is one in which an upper part of the container is opened and the edge of the upper part has a flange. Alternatively, the containers may be those where the flange is molded into a curling shape, or those which have no flanges. In addition, the bottom part of the containers may be closed or opened.

Note that the paper-made molding container, which is obtained by press molding the base paper of the present invention for a molding container, have a smooth surface, beautiful appearance, and greater degree of freedom in terms of shape compared to those obtained by using conventional base paper or the like. In other words, the base paper of the present invention for a molding container not only enables the achievement of containers having various shapes, which are impossible to achieve with conventional paper-made containers, but also enables the achievement of containers having complex designs such as letters, figures, and even cartoon characters.

By using such a paper-made molding container as a baking pan, it is possible to produce food products which have a more beautiful appearance and various complex shapes.

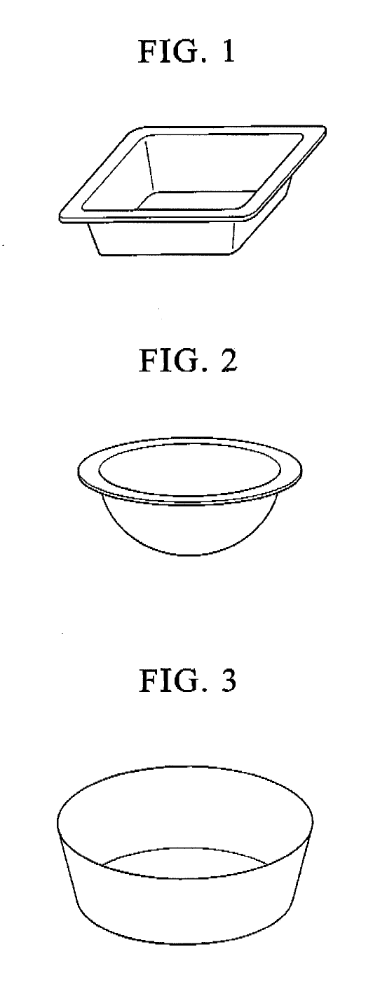

The paper-made molding container can be produced so that the outer shape thereof is arbitrarily shaped like squares, rectangles, circles, and ellipses when shown in a plan view. In any case, corners are usually rounded. FIGS. 1 and 2 are sketches showing one example of the press molded container of the present invention.

Additionally, it is possible to provide the abovementioned paper-made molding container with holes in the bottom surface thereof when used as a baking pan. By providing such holes in the bottom surface, the following advantages are achieved. One is that heat is readily conducted during cooking, and thus foods readily turn brown. Another is that since the gases generated from food products are readily released during cooking due to the compensation of gas permeability or water vapor permeability, deformation of a baking pan and the food products produced therefrom because of the increase in internal pressure is prevented.

Further, in the paper-made molding containers which are used as a baking pan, the bottom surface part is not necessarily required and, for example, they can be tubular (FIG. 3). In such a case, the bottom surface part is preferably produced by being stamped out after press molding or at the same time as press molding. In addition, when using a baking pan with no bottom surface parts, general procedures are that the aforementioned baking pan is laid onto the top board of a cooking utensil such as an oven, and thereafter filled with ingredients for food products to cook.

Note that other than adopting the aforementioned press molding, it is possible to mold the base paper of the present invention for a molding container into arbitrary shapes such as boxes and trays just like common paperboard using a normal casemaker.

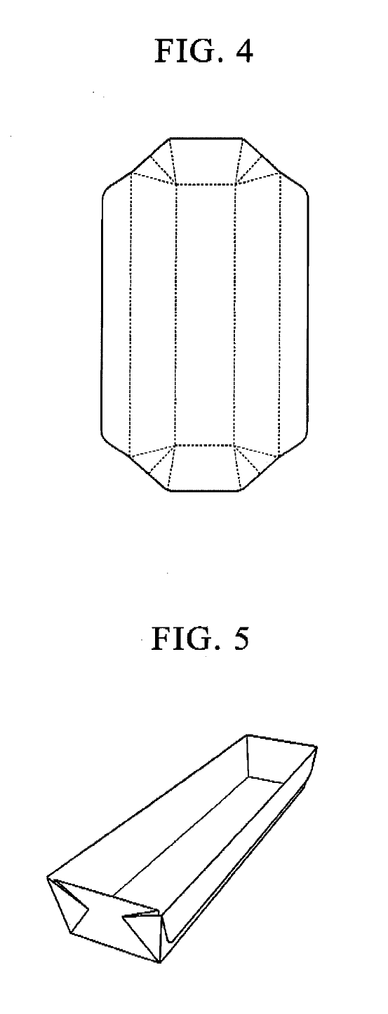

It should also be noted that when the molded base paper of the present invention is processed into a tray carton to be used as a baking pan, the following form is particularly preferable since the bottom surface and side surface are constituted from one blank sheet and are seamless, and thus contents do not leak outside from a seam. That is, a type of tray carton (FIG. 5) which was formed by compartmentalizing a blank sheet into the bottom surface and side surface using ruled lines (FIG. 4), folding said side surface parts upright folding corners of side surface parts, and laminating and joining them to the outer side of the side surface parts by means of gluing or the like.

In addition, in the molded base paper of the present invention, breaking of papers is unlikely to occur even when ruled lines are drawn deeply at the time of carton forming compared to normal paperboards, which use kraft pulp or recycled pulp as a stock, which has no differences in density between layers even when made into a multilayered structure, and which is made so that all the layers therein have higher density than that of the base paper of the present invention for a molding container. By drawing ruled lines deeply, it is difficult to generate gaps at the parts, which are made by the folding and joining, and thus accuracy of forming increases. Accordingly, it is possible to obtain a paper-made molding container which has a more ordered shape using the base paper of the present invention for a molding container. Furthermore, there is also an advantage in that silicone coating is not damaged when drawing ruled lines because of good moldability of the paper.

In addition, the tray carton container obtained by using the molded base paper of the present invention has a lower density and also has a greater amount of compressive deformation in the thickness direction when applied with the same load compared to the aforementioned container of a same basis weight which is obtained by using a normal paperboard. For this reason, ruled lines, which are added as a crease at the time of forming a tray carton, can be drawn deeply, and thus shape stability when a tray carton is formed is excellent. Accordingly, the tray carton container is extremely excellent in terms of durability when used repeatedly as a baking pan.

Note that the change in the shape of a paper-made molding container can be carried out simply by the adjustment of shape, position of ruled lines, and folding machine at the time of stamping out the blank sheet.

### EXAMPLES

The present invention will be described in further detail below using Examples.

### Example 1

Using a disc refiner, commercially available NBKP was beaten to 550 mlcsf (Tappi T-227: Canadian Standard); radiata pine TMP was beaten to 300 mlcsf; and commercially available NUKP was beaten to 550 mlcsf.

By using them as stocks, a substrate paper was obtained using a multilayer-combining paper machine and using a paper board of 350 g/m², which was composed of three layers; i.e. the first layer of 40 g/m² NBKP, second layer of 260 g/m² TMP, and third layer of 50 g/m² NUKP. The tensile strength, breaking elongation, critical compressive stress, and amount of compressive deformation in the thickness direction of this substrate paper were determined by the measuring methods described later.

The base paper of the present invention for a molding container was obtained by coating 2.0 g/m² (solid content) of a silicone resin release agent (KS835: solvent manufactured by Shin-Etsu Chemical Co., Ltd.) onto the aforementioned substrate paper using a test gravure coater.

Additionally, the base paper was molded into a baking-pan shape by press molding to obtain a paper-made molding container.

Note that the shape of the paper-made molding container obtained above can be seen in FIG. 1 and the size thereof was 80 mm×80 mm and almost quadrangle at its upper opening section and had a depth of 30 mm.

### Example 2

The base paper for a molding container and paper-made molding container of the present invention were obtained as in Example 1 except that the substrate paper was obtained by using a paper board of 280 g/m², which was composed of three layers; i.e. the first layer of 40 g/m² NBKP, second layer of 200 g/m² TMP, and third layer of 40 g/m² NUKP.

### Example 3

The base paper for a molding container and paper-made molding container of the present invention were obtained as in Example 1 except that the substrate paper was obtained by using a paper board of 330 g/m², which was composed of three layers; i.e. the first layer of 40 g/m² NBKP, second layer of 240 g/m² TMP, and third layer of 50 g/m² NUKP.

### Example 4

As an undercoat layer, 0.5 g/m² (solid content) of PVA (Denkapoval PVA 117 manufactured by Denki Kagaku Kogyo Kabushiki Kaisha) was coated onto the substrate paper obtained in Example 1 and moreover, 1.5 g/m² (solid content) of the same silicone release agent used in Example 1 was then coated thereon using a test gravure coater to obtain the base paper for a molding container and subsequently paper-made molding container.

### Comparative Example 1

A base paper for a molding container was prepared by laminating 25 g/m² of polybutyleneterephthalate (PBT) resin (Juranex manufactured by Polyplastics Co., Ltd.) onto the surface of the substrate paper obtained in Example 1 using an extrusion laminating machine. Moreover, said base paper for a molding container was subjected to press molding as in Example 1 to obtain a paper-made molding container.

### Comparative Example 2

Using a disc refiner, commercially available LBKP was beaten to 300 mlcsf. Using each stock; i.e. the abovementioned LBKP, and NBKP and NUKP obtained as in Example 1, a substrate paper was obtained as in Example 1 using a paper board of 330 g/m² which was composed of three layers; i.e. the first layer of 40 g/m² NBKP, second layer of 240 g/m² LBKP/NBKP (=70/30), and third layer of 50 g/m² NUKP. The tensile strength, breaking elongation, critical compressive stress, and amount of compressive deformation in the thickness direction of this substrate paper were determined by the measuring methods described later.

A base paper for a molding container was prepared by laminating 20 g/m² of polymethylpentene (PMP) resin (TPX manufactured by Mitsui Chemicals, Inc.) onto the surface of said substrate paper using an extrusion laminating machine. Moreover, said base paper for a molding container was subjected to press molding as in Example 1 to obtain a paper-made molding container.

### Comparative Example 3

Using each stock; i.e. NBKP and NUKP obtained as in Example 1 and LBKP obtained in Comparative Example 2, a substrate paper was obtained as in Example 1 using a paper board of 310 g/m² which was composed of three layers; i.e. the first layer of 40 g/m² NBKP, second layer of 220 g/m² LBKP/NBKP (=70/30), and third layer of 50 g/m² NUKP. The tensile strength, breaking elongation, critical compressive stress, and amount of compressive deformation in thickness direction of this substrate paper were determined by the measuring methods described later.

A base paper for a molding container was prepared by laminating 25 g/m² of polybutyleneterephthalate (PBT) resin (Juranex manufactured by Polyplastics Co., Ltd.) onto the surface of said substrate paper using an extrusion laminating machine. Moreover, said base paper for a molding container was subjected to press molding as in Example 1 to obtain a paper-made molding container.

### Comparative Example 4

A commercially available baking pan made of aluminum (part number 281 manufactured by Toyo Aluminiumi Ekco Products Inc.) was evaluated as a baking pan.

### Comparative Example 5

A base paper for a molding container was obtained by coating the silicone resin release agent as in Example 1 onto the surface of the substrate paper obtained in Comparative Example 3. Using this, a paper-made molding container was obtained by press molding as in Example 1.

### [Evaluation Method]

The base papers for a molding container and paper-made molding containers obtained in the abovementioned Examples 1 to 4 and Comparative Examples 1 to 4 were evaluated by the following methods. Results are shown in Table 1.

### (1) Density of Each Paper Layer

Using the substrate papers obtained in Examples and Comparative Examples, the thickness (mm) and basis weight (g/m²) of respective layers were determined by delaminating each layer using a ply separation method described in the peel strength test for the combined layers of a paperboard defined in JIS-P8139. Note that since each layer, which was peeled off, was napped due to delamination and the thickness thereof was greater than the actual thickness, the density of each layer was calculated by calculating a correction factor by the following method and correcting the thickness values of each layer after delamination.

(Correction factor value)=(total layer thickness before delamination)/(summed value of thickness of each layer after delamination)

When the delamination of each layer is difficult by the abovementioned ply separation method described in the peel strength test for the combined layers of a paperboard defined in JIS-P8139, stock of multilayer-combined sheet was immersed in hot water of 60° C. for 1 hour and thereafter, it was peeled separately into a surface layer, intermediate layer, and back layer. Respective layers which were peeled off were dried and the thickness (mm) and basis weight (g/m²) thereof were determined. Thereafter, the abovementioned correction factor value was calculated as described above, and the density of each layer was calculated by correcting the thickness of each layer after delamination.

### (2) Tensile Strength

Test pieces obtained by cutting the substrate papers obtained in Examples and Comparative Examples to a width of 15 mm and length of 250 mm respectively, in the flow direction and width direction were subjected to a conditioning treatment under conditions of 23° C. and 50% RH for at least 24 hours. Then, the tensile strength of the test pieces was determined using a Strograph M2 tester (manufactured by Toyo Seiki Seisaku-Sho, Ltd.) at a stress rate of 20 mm/min in accordance with JIS-P8113.

### (3) Breaking Elongation

Test pieces obtained by cutting the substrate papers obtained in Examples and Comparative Examples to a width of 15 mm and length of 250 mm in the flow direction and width direction respectively, were subjected to a conditioning treatment under conditions of 23° C. and 50% RH for at least 24 hours. Then, the breaking elongation of the test pieces was determined using a Strograph M2 tester (manufactured by Toyo Seiki Seisaku-Sho, Ltd.) at a stress rate of 20 mm/min in accordance with JIS-P8113.

### (4) Critical Compressive Stress

Test pieces obtained by cutting the substrate papers obtained in Examples and Comparative Examples to a width of 12.7 mm and length of 152.4 mm in the flow direction and width direction respectively, were subjected to a conditioning treatment under conditions of 23° C. and 50% RH for at least 24 hours. Then, the compressive strength A of the test pieces was determined using a digital ring crush tester X-1104 (manufactured by Orientec Co., Ltd.) in accordance with JIS-P8126. Further, the area B of the loaded part of the test piece in the course of determining compressive strength was determined. The critical compressive stress was calculated from the following formula:

Critical compressive stress−A/B

where the unit of critical compressive stress is MPa, unit of compressive strength is N, and the area of the loaded part of the test piece is calculated by the formula:

(Thickness of test piece)(mm)×152.4 mm

in which the thickness of the test piece was a value determined in accordance with JIS-P8118 by using a sample which was subjected to a conditioning treatment under conditions of 23° C. and 50% RH for at least 24 hours.

### (5) Amount of Compressive Deformation

Test pieces obtained by cutting the substrate papers obtained in Examples and Comparative Examples to 50 mm×50 mm were subjected to a conditioning treatment under conditions of 23° C. and 50% RH for at least 24 hours. Thereafter, each test piece was compressed in the thickness direction using a Strograph M2 tester (manufactured by Toyo Seiki Seisaku-Sho, Ltd.) at a compressive rate of 1.0 mm/min to draw a stress-distortion curve to determine the amount of compression (amount of distortion) under a compressive stress of 20 kgf/cm².

### (6) Air Permeability

Air permeability of the base papers for a molding container, which were obtained in respective Examples and Comparative Examples, was measured in accordance with JIS-P8117.

### (7) Press Moldability

Presence/absence of breaking on the paper layer surface of the corner part and smoothness of the flange part in the paper-made molding container, which was press molded, were evaluated. Those which were finished in a condition where breaking of the paper layer was absent and the flange part collapsed smoothly were rated as “0”, those in which breaking of the paper layer occurred in any one of the corner parts were rated as “A”, and those in which breaking of the paper layer occurred in 2 or more parts or those in which the flange was not smooth were rated as “x”.

### (8) Cooking Suitability

A baking pan, which was obtained by press molding a base paper for a molding container, was filled with frozen dough (manufactured by Ajinomoto Co., Inc.) and a cooking test in an oven at 220° C. for 15 minutes was performed to carry out the evaluation of cooking suitability.

Evaluation method was as follows; i.e. those in which the part of a baked bread which was in contact with the container bottom was turning brown and were completely baked were rated as “∘”, and those which did not turn brown and were half-baked were rated as “x”.

### (9) Release Properties

The abovementioned cooking test in section (8) was repeated 20 times for each container to evaluate release properties between bread and the baking pan. The evaluation method was as follows; i.e. those in which release properties between baked bread and the baking pan (the state where bread was separated with no difficulties and dough did not attach to the baking pan) were retained were rated as “∘”, those in which the release properties were impaired after repeating the test 15 times or more were rated as “Δ”, and those in which the release properties were impaired before repeating the test 15 times were rated as “x”.

### (10) Shape Stability

When the abovementioned cooking test in section (8) was repeated 20 times, distortion in terms of the shape of the paper-made molding container was visually observed after each test. Those in which almost no distortion was observed compared to the state before the test even after being used 20 times were rated as “∘”, those in which distortion was observed after being used 20 times were rated as “Δ”, and those in which distortion was observed after being used several times were rated as “x”.

TABLE 1

| | | Ex. 1 | Ex. 2 | Ex. 3 | Ex. 4 |
|---|---|---|---|---|---|
| Basis weight of | g/m² | 350 | 280 | 330 | 350 |
| substrate paper | | | | | |
| Density (total of | g/cm³ | 0.638 | 0.647 | 0.642 | 0.638 |
| all layers) | | | | | |
| (First layer) | g/cm³ | 0.79 | 0.79 | 0.79 | 0.79 |
| (Second layer) | g/cm³ | 0.60 | 0.60 | 0.60 | 0.60 |
| (Third layer) | g/cm³ | 0.79 | 0.79 | 0.79 | 0.79 |
| Air permeability | Seconds | 400 | 350 | 380 | 410 |
| Surface treatment | | Silicone | Silicone | Silicone | Silicone |
| | | resin | resin | resin | resin |
| Tensile strength | kN/m | 21.5 | 17.2 | 19.0 | 21.5 |
| Break elongation | % | 3.5 | 2.9 | 3.1 | 3.5 |
| Compressive | MPa | 7.8 | 6.4 | 7.3 | 7.8 |
| stress | | | | | |
| Amount of | % | 18 | 16 | 17 | 18 |
| deformation | | | | | |
| Moldability | | ∘ | ∘ | ∘ | ∘ |
| Cooking | | ∘ | ∘ | ∘ | ∘ |
| suitability | | | | | |
| Release properties | | ∘ | ∘ | ∘ | ∘ |
| Shape stability | | ∘ | ∘ | ∘ | ∘ |

| | | Comp. | Comp. | Comp. | Comp. | Comp. |
|---|---|---|---|---|---|---|
| | | Ex. 1 | Ex. 2 | Ex. 3 | Ex. 4 | Ex. 5 |
| Basis weight | g/m² | 350 | 330 | 310 | 170 | 310 |
| of substrate | | | | | | |
| paper | | | | | | |
| Density (total | g/cm³ | 0.640 | 0.750 | 0.740 | 2.730 | 0.740 |
| of all layers) | | | | | | |
| (First layer) | g/cm³ | 0.79 | 0.79 | 0.79 | — | 0.79 |
| (Second layer) | g/cm³ | 0.60 | 0.73 | 0.72 | — | 0.72 |
| (Third layer) | g/cm³ | 0.79 | 0.79 | 0.79 | — | 0.79 |
| Air | Seconds | ∞ | ∞ | ∞ | ∞ | 500 |
| permeability | | | | | | |
| Surface | | PBT | PMP | PBT | None | Silicone |
| treatment | | | | | | resin |
| Tensile | kN/m | 21.5 | 19.8 | 18.6 | — | 18.6 |
| strength | | | | | | |
| Break | % | 3.5 | 3.1 | 2.2 | — | 2.2 |
| elongation | | | | | | |
| Compressive | MPa | 7.9 | 16.3 | 15.3 | — | 15.3 |
| stress | | | | | | |
| Amount of | % | 18 | 11 | 11 | — | 11 |
| deformation | | | | | | |
| Moldability | | ∘ | ∘ | Δ | — | Δ |
| Cooking | | x | x | x | x | ∘ |
| suitability | | | | | | |
| Release | | x | Δ | x | x | ∘ |
| properties | | | | | | |
| Shape stability | | x | x | x | ∘ | Δ |

Examples where containers were molded into a tray carton shape are shown below.

### Example 5

A paper-made molding container (FIG. 5) was obtained as follows using the base paper obtained in Example 1 for a molding container. The base paper was stamped out into a predetermined shape (FIG. 4), compartmentalized into a bottom surface and side surface using ruled lines, folding said side surface parts upright, folding and laminating corners of side surface parts, and pasting the external side surface of the container with the corner part using a vinyl acetate-based adhesive.

### Comparative Example 6

A paper-made molding container was obtained as in Example 5 using the base paper obtained in Comparative Example 5 for a molding container.

The paper-made molding containers obtained in Example 5 and Comparative Example 6 were evaluated using the same methods as those used in Examples 1 to 4 and Comparative Examples 1 to 5 described earlier (except press moldability).

Results are shown in Table 2.

TABLE 2

| | | Ex. 5 | Comp. Ex. 6 |
|---|---|---|---|
| Basis weight of substrate | g/m² | 350 | 310 |
| paper | | | |
| Density (total of all layers) | g/cm³ | 0.638 | 0.740 |
| (First layer) | g/cm³ | 0.79 | 0.79 |
| (Second layer) | g/cm³ | 0.60 | 0.72 |
| (Third layer) | g/cm³ | 0.79 | 0.79 |
| Air permeability | Seconds | 400 | 500 |
| Surface treatment | | Silicone resin | Silicone resin |
| Tensile strength | kN/m | 21.5 | 25.8 |
| Break elongation | % | 3.5 | 2.2 |
| Compressive stress | MPa | 7.8 | 15.3 |
| Amount of deformation | % | 18 | 11 |
| Cooking suitability | | ∘ | ∘ |
| Release properties | | ∘ | ∘ |
| Shape stability | | ∘ | x |

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A base paper for a molding container comprising:
a substrate paper having a basis weight of 100 to 500 g/m² and overall density of 0.4 to 0.7 g/cm³ and which has a high density layer having a density of 0.7 to 0.9 g/cm³ and a low density layer having a density of less than 0.7 g/cm³; and
a release agent layer which is provided on at least one surface of the substrate paper and which may be provided via an undercoat layer,
wherein the low density layer is mainly constituted of at least one pulp selected from the group consisting of mechanical pulp, curled fibers, and mercerized pulp; and
wherein air permeability defined in JIS-P8117 is 100 to 5000.

2. The base paper for a molding container according to claim 1, wherein the base substrate paper has
a tensile strength (defined in JIS-P8113) of at least 2.0 kN/m,
a breaking elongation (defined in JIS-P8113) of at least 1.5%,
a critical compressive stress, which is derived by dividing compressive strength (defined in JIS-P8126) by area of loaded part of a test piece in the determination of the compressive strength, within a range of 1 to 10 MPa, and
an amount of compressive deformation of at least 10% when 20 kgf/cm² of compressive stress is applied in a thickness direction.

3. The base paper for a molding container according to claim 1 or 2, wherein the release agent layer is formed from a silicone resin.

4. A container made by press molding which is produced by using a base paper for a molding container of claim 1 or 2.

5. A container made by press molding which is produced by using a base paper for a molding container of claim 3.

6. A tray carton which is produced by using a base paper for a molding container of claim 1 or 2.

7. A tray carton which is produced by using a base paper for a molding container of claim 3.

8. The container made by press molding according to claim 4 or 5, wherein the container is used as a baking pan for cooking.

9. The tray carton according to claim 6 or 7, wherein the container is used as a baking pan for cooking.
